(19) United States
(12) Patent Application Publication
(10) Pub. No.: US 2017/0007073 A1
(43) Pub. Date: Jan. 12, 2017

(54) BBQ GRILL INSERT AND BBQ GRILL ASSEMBLY USING THE SAME

(71) Applicant: Gioni Bianchini, Sunnyvale, CA (US)

(72) Inventor: Gioni Bianchini, Sunnyvale, CA (US)

(21) Appl. No.: 14/791,778

(22) Filed: Jul. 6, 2015

(51) Int. Cl. A47J 37/07; F24B 1/182; F24B 1/199

(52) U.S. Cl. CPC A47J 37/0786; F24B 1/199; F24B 1/182

(57) ABSTRACT

A BBQ grill insert includes a main body and a plurality of dimples, wherein the main body has a pot-like shape for containing charcoals, and has a base inside the pot-like shape and an opening opposite to the base. The dimples are disposed on the base, and each of the dimples rises to form a top and a hole on the top. The holes promote the under flow of the BBQ grill insert, and the dimples keep the holes clean and prevent ashes migrate through the holes when the charcoals burn in the main body. Therefore, the heat transferring efficiency of the BBQ grill insert could be promoted and the cleaning the BBQ grill assembly, which using the BBQ grill insert, becomes easier.

### FIELD OF THE INVENTION

This invention relates to a BBQ grill insert and BBQ grill assembly, and more particularly, to a BBQ grill insert which is able to promote the air flow and the BBQ grill assembly using the BBQ grill insert.

### BACKGROUND

The BBQ (barbecue) grill assembly is often used in the party for providing grilled foods. In the prior art, the BBQ grill assembly is provided with a housing and a grill insert. The grill insert is put in the housing and used for containing charcoals or other fuel materials. The BBQ grill assembly further comprises a support element connected to the housing and a grill grid detachably put on the opening of the housing.

Please refer to FIG. 1. FIG. 1 is a cross-sectional view illustrating a BBQ grill assembly 1 of the prior art. As shown in FIG. 1, the BBQ grill assembly 1 includes a housing 10, a grill insert 12, and a grill grid 14. The grill insert 12 is detachably disposed in the housing 10 and used for containing charcoals 16. The housing 10 has a first opening and the grill insert 12 has a second opening facing the same direction with the first opening. The grill grid 14 is detachably put on the first opening and the second opening. During operation of the BBQ grill assembly 1, the charcoals 16 burn in the grill insert 12 to generate heat to grill the foods on the grill grid 14.

The heat generated by the charcoals 16 is carried by the air flow in the grill insert 12 to the foods on the grill grid 14, that is to say, the air flow decides the burning efficiency of the charcoals 16 and the heat transferring efficiency. However, the design of the grill insert 12 of the prior art obstructs the air flow, especially the air flow near the base of the grill insert 12.

Therefore, the BBQ grill assembly should be improved to promote the efficiency thereof

### SUMMARY OF THE INVENTION

One object of the present invention is to provide a BBQ grill insert. According to an embodiment of the invention, the BBQ grill insert comprises a main body and a plurality of dimples. The main body has a pot-like shape for containing charcoals, a base inside the pot-like shape and an opening opposite to the base. The dimples are disposed on the base of the main body. Each of the dimples has a top and a hole formed on the top.

During operation of the BBQ grill insert, the holes promote the under flow of the BBQ grill insert, and furthermore, the dimples decreasing the likelihood of ashes migrating through the holes and or clogging them.

Another object of the present invention is to provide a BBQ grill assembly. According to an embodiment of the invention, the BBQ grill assembly includes a housing, a top grill grid, and a BBQ grill insert. The housing forms a containing space and has a support element and a first opening. The top grill grid is detachably disposed on the first opening for placing the foods thereon. The BBQ grill insert is detachably disposed in containing space of the housing.

The BBQ grill insert further comprises a main body and a plurality of dimples. The main body has a pot-like shape for containing charcoals, a base inside the pot-like shape and a second opening opposite to the base. The dimples are disposed on the base of the main body. Each of the dimples has a top and a hole formed on the top.

During operation of the BBQ grill insert, the holes promote the under flow of the BBQ grill insert, and furthermore, the dimples decreasing the likelihood of ashes migrating through the holes and or clogging them to keep the holes and the housing clean. Therefore, the efficiency of the BBQ grill assembly is improved because the air flow is promoted.

On the advantages and the spirit of the invention, it can be understood further by the following invention descriptions and attached drawings.

### BRIEF DESCRIPTION OF THE DRAWINGS

FIG. 1 is a cross-sectional view illustrating a BBQ grill assembly of the prior art.

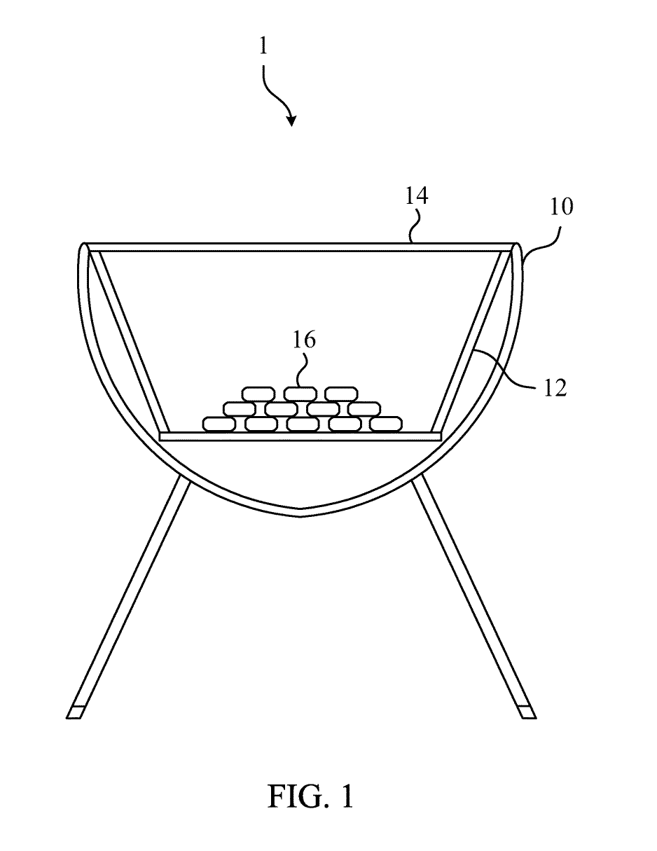

FIG. 2 is a schematic drawing illustrating a BBQ grill insert according to an embodiment of the present invention.

FIG. 3 is a cross-sectional view illustrating a BBQ grill assembly according to an embodiment of the invention.

### DETAILED DESCRIPTION

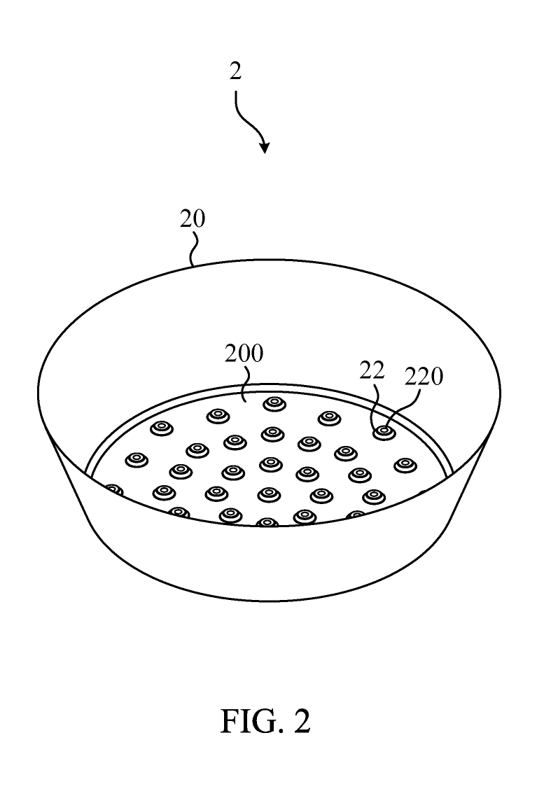

Please refer to FIG. 2. FIG. 2 is a schematic drawing illustrating a BBQ grill insert 2 according to an embodiment of the present invention. As shown in FIG. 2, the BBQ grill insert 2 includes a main body 20. The main body 20 has a form of pot-like shape adapted to containing charcoal. The main body 20 further comprises a base 200 inside the pot-like shape and an opening opposite to the base 200. The main body 20 could be made of aluminum. In this embodiment, the main body 20 is formed by aluminum foils. In practice, the main body 20 could be made of other material which is able to contain charcoal and to bear the burning of the charcoal therein.

The BBQ grill insert 2 further includes a plurality of dimples 22 formed on the base 200 of the main body 20. As shown in FIG. 2, each of the dimples 22 respectively rises from the base 200 and respectively has a top. The dimples 22 could be arranged in one array or more arrays on the base 200. There is a hole 220 formed on each top of the dimples 22. The dimples 22 could be made of the same material with that of the main body 20, such as aluminum or stainless steel.

During operation of the BBQ grill insert, the charcoals are placed on the base 200 and dimples 22 and burn, and the air flows from the outside of the main body 20 into the main body 20 through the holes 220. Therefore, the air flow near the base 200, which is regarded as a under flow, is promoted. The promoted under flow increases the burning efficiency and heat transferring efficiency of the BBQ grill insert 2.

The dimples 22 rise from the base 200 and the holes 220 are formed on the top of the dimples 22. Because the air flow keeps entering the main body 20 through the holes 220 and the dimples 22 are higher then the base 200, the ashes generated in the combustion of the charcoals or the other impurities (such as BBQ sauce) would be blown from the top of dimples 22 and fall to the base 200, and the upward air flow from the holes 220 is hard to blow the ashes on the base 200. In other words, the dimples 22 decrease the likelihood of that the ashes migrate through the holes 220 or clog the holes 220. After using the BBQ grill insert 2, the ashes or the impurities could be easily removed together with the BBQ grill insert 2, so that the BBQ grill assembly, which contains the BBQ grill insert during operation, could be easily cleaned up because not many ashes or impurities dropped therein.

The BBQ grill insert 2 can further include a lid to cover the opening. The lid is able to make a closed space in the main body 20, and then prevent the charcoals from dropping out from the main body 20, so that the charcoals could be moved or sold with the BBQ grill insert 2 easily. The lid is removed to expose the charcoals during operation of the BBQ grill insert 2 and the heat generated could be transferred out of the opening of the main body 20.

As described above, the under flow of the BBQ grill insert of the invention could be promoted by the holes and the ashes or other impurities would not migrate through the holes to the outside of the main body or clog the holes, resulting in fine heat transferring efficiency and ease of cleaning the BBQ grill assembly which uses the BB grill insert.

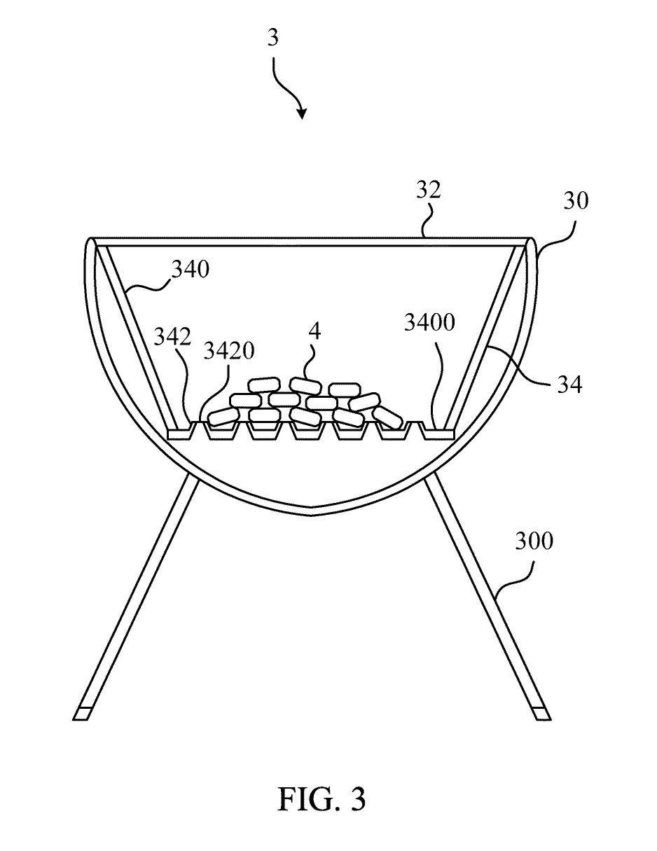

Please refer to FIG. 3. FIG. 3 is a cross-sectional view illustrating a BBQ grill assembly 3 according to an embodiment of the invention. As shown in FIG. 3, the BBQ grill assembly 3 includes a housing 30, a top grill grid 32, and a BBQ grill insert 34. The housing 30 is used for containing the BBQ grill insert 34 and supporting the top grill grid 32 so as to grill foods. The housing 30 also has a support element 300 to help the housing 30 to stand and raise the grill grid 32 and the BBQ grill insert 34 up to a suitable height. The housing 30 includes a containing space to contain the BBQ grill insert 34 and a first opening, so that the generated heat could be transferred through the first opening. The top grill grid 32 could be detachably disposed on the housing 30 to cover the first opening for placing the foods thereon, and then the generated heat would grill the foods on the top grill grid 32.

The BBQ grill insert 34 could be detachably contained in the containing space of the housing 30. The BBQ grill 34 further includes a main body 340 and dimples 342. The main body 340 has a form of pot-like shape adapted to containing charcoals 4. The main body 340 further comprises a base 3400 inside the pot-like shape and a second opening opposite to the base 3400. The second opening of the main body 340 face the same direction with that of the first opening of the housing 30, so that the top grill grid 32 covers the first opening and the second opening. It should be noted that there is a space between the bottom of the main body 340 of the BBQ grill insert 34 and the housing 30.

The dimples 342 are formed on the base 3400 of the main body 340, and in more detail, each of the dimples 342 respectively rises from the base 3400 and respectively has a top. The dimples 342 could be arranged in one array or more arrays on the base 3400. There is a hole 3420 formed on each top of the dimples 342. The same with the above embodiment, the main body 340 and the dimples 342 could be made of aluminum, or other material which is able to contain charcoal and to bear the burning of the charcoal therein.

During operation of the BBQ grill assembly 3, the charcoals 4 burn in the main body 340 of the BBQ grill insert 340. The heat generated by the charcoals 4 heats the air in the space between the bottom of the main body 340 and the housing 30, and then the air rises into the main body 340 through the holes 3420 to promote the under flow in the main body 340. The heat transferring efficiency of the BBQ grill insert 340 is improved because the under flow is promoted. Also, the holes 3420 are disposed on the dimples 342, and the ashes generated in the combustion of the charcoals 4 or other impurities (such as BBQ sauce, oil, or fat) would be blown by the under flow from the top of dimples 342 and fall to the base 3400. It should be noted that the holes 3420 are higher than the base 3400 and the under flow is upward, so that the under flow is hard to blow the ashes and the impurities on the base 3400. Therefore, the likelihood of the ashes or other impurities clogging the holes 3420 would be decreased, and the under flow could be kept. Also, the likelihood of the ashes or other impurities migrating through the holes 3420 would be decreased, so that the housing 30 could be kept clean easily by folding up and removing the BBQ grill insert 34. In more detail, after operation of the BBQ grill assembly 3, a great portion of the generated ashes or impurities could be kept in the BBQ grill insert 34 and then removed with the BBQ grill insert 34, resulting in ease of cleaning the housing 30 of the BBQ grill assembly 3.

The BBQ grill insert 34 can further include a lid to cover the second opening in practice. The lid prevents the charcoals 4 from dropping out from the main body 340, so that the charcoals 4 could be moved or sold with the BBQ grill insert 34 easily. The lid is removed during operation of the BBQ grill assembly 3 to expose the charcoals 4, and the heat generated by the charcoals 4 burning could be transferred to the top grill grid 32.

As described above, the under flow of the BBQ grill insert used in the BBQ grill assembly of the invention could be promoted by the holes and the ashes or other impurities would not migrate through the holes to the housing of the BBQ grill assembly or clog the holes, resulting in fine heat transferring efficiency and ease of cleaning the BBQ grill assembly.

Although the present invention has been illustrated and described with reference to the preferred embodiment thereof, it should be understood that it is in no way limited to the details of such embodiment but is capable of numerous modifications within the scope of the appended claims.

1. A BBQ grill insert, comprising:
a main body, having a pot-like shape for containing charcoals, the main body further having a base inside the pot-like shape and an opening opposite to the base; and
a plurality of dimples, disposed on the base of the main body, each of the dimples having a top and a hole formed on the top;
wherein the holes promote an under flow of the BBQ grill insert, and the dimples keep the holes clean and prevent ashes from migrating through the holes when the charcoals burn in the main body.

2. The BBQ grill insert of claim 1, further comprising:
a lid, covering the opening;
wherein the lid is removed during operation of the BBQ grill insert.

3. The BBQ grill insert of claim 1, wherein the dimples are arranged in a array.

4. The BBQ grill insert of claim 1, wherein the main body is made of aluminum.

5. The BBQ grill insert of claim 4, wherein the pot-like shape of the main body is formed by aluminum foils.

6. A BBQ grill assembly, comprising:
a housing, having a support element and a first opening;
a top grill grid, detachably disposed on the housing to cover the first opening for placing foods thereon; and
a BBQ grill insert, detachably disposed in the housing, the BBQ grill insert further comprising:
a main body, having a pot-like shape for containing charcoals, the main body further having a base inside the pot-like shape and a second opening opposite to the base; and
a plurality of dimples, disposed on the base inside the main body, each of the dimples having a top and a hole formed on the top;
wherein the holes promote an under flow of the BBQ grill insert, and the dimples keep the holes clean and prevent ashes from migrating through the holes to the housing when the charcoals burn in the main body.

7. The BBQ grill assembly of claim 6, wherein the BBQ grill insert further comprises a lid covering the second opening, and the lid is removed during operation of the BBQ grill insert.

8. The BBQ grill assembly of claim 6, wherein the dimples are arranged in a array.

9. The BBQ grill assembly of claim 6, wherein the main body is made of aluminum.

10. The BBQ grill assembly of claim 6, wherein the pot-like shape of the main body is formed by aluminum foil.
